(19) United States
(12) Patent Application Publication
(10) Pub. No.: US 2018/0247719 A1
(43) Pub. Date: Aug. 30, 2018

(54) Method for enabling low energy nuclear reactions by the Rotator Collapse Field-Coupled (RCFC) effect

(71) Applicant: Jürg Albert Wyttenbach, Affoltern am Albis (CH)

(72) Inventor: Jürg Albert Wyttenbach, Affoltern am Albis (CH)

(21) Appl. No.: 15/444,580

(22) Filed: Feb. 28, 2017

(51) Int. Cl. G21B 3/00

(52) U.S. Cl. CPC G21B 3/006

(57) ABSTRACT

In 1989 Fleischmann & Pons experimentally confirmed the existence of a new class of nuclear reactions, today called LENR (or CMNR) low energy nuclear reactions (condensed matter nuclear reactions). The presented Rotator Collapse Field-Coupled (RCFC) effect or method is entirely based on well known physical laws and has strong experimental background, revealed to the public in a large number of papers, proceedings etc. We herein provide the parameters, methods to successfully produce such an effect.

### BACKGROUND OF THE INVENTION

This invention relates to atomic (nuclear) transformation reactions, known to the field as LENR—low-energy nuclear reactions—or CMNR—condensed matter nuclear reactions.

LENR/CMNR processes run at a much lower energy/space usage—scale, than processes in nuclear fission/fusion plants need and are known to produce very low level nuclear waste.

So far no common accepted theory exists to explain LENR/CMNS. Nevertheless many concrete applications of such underlaying reactions were accepted to patent status.

### As EP268′271A1 WO2009/125444A1; US 2016/0051957; EP 2 702′593B1/A1 WO2010 058288; US 20150371723 A1; WO2014189799; US 2017/0022055

We herein, as a novelty, describe the core physical process, which guides a large number of different LENR reactions. We present a set of varying methods to attain such transformations. This process is named Rotators Collapse Field-Coupled LENR reaction or short RCFC-(LENR)-reaction.

The presented method can be used in different LENR areas, with varying material compositions.

We will use the condensed matter Ni—Li—H system as a sample to explain the laws and methods of such processes. The same laws and rules also hold for e.g. Pd-D systems or any adequate PdNiZrCaCuTiMn . . . other elements—mixture of used materials.

### LITERATURE REFERENCED IN THE FOLLOWING TEXT

[L1] Jonathan Phillips,* Chun-Ku Chen, and Toshi Shiina University of New Mexico EVIDENCE OF CATALYTIC PRODUCTION OF HOT ATOMIC HYDROGEN IN RF GENERATED HYDROGEN/HELIUM PLASMAS
[L2] R. Mills GUT ISBN 978-0-9635171-5-9
[L3] Aringazin; Toroidal configuration of the orbit of the electron of the hydrogen atom under strong external magnetic fields http://www.arxiv.org/abs/physics/0202049v1
[L4] Petr Dohnal doctoral thesis: Electron Ion Recombination in Low Temperature Plasma—Department of Surface and Plasma Science Charles University in Prague

### BRIEF SUMMARY OF THE INVENTION

Physical processes, called fusion of nuclei or nuclear fusion, are well described by the energy needed to bring such nuclei together, long and close enough, for that the strong nuclear force finally overtakes the reaction and binds the two nuclei to a new compound nucleus.

This energy needed to induce fusion is primarily used to overcome the so called coulomb barrier.

The art of fusion is to produce a compound nucleus, that is stable and does not decay due to internal instability.

Such instabilities are caused by a) excess energy—to much energy delivered to overcome the coulomb barrier; or high mass excess energy, due to e=mc², where m is the mass difference between created and reacting nuclei.

Such instabilities may also be caused/further enhanced by asymmetric impact—(kinetic meeting angle—the momentum vectors of two meeting nuclei—strongly deviates from 180 degrees) fusion, which leads to highly asymmetric excitations of the target/generated nucleus.

The energy dissipation by the newborn nucleus must also, preferably follow certain rules like: Avoiding hard radiation, expelling of nuclear particles (neutrons, high energy electron, positrons, protons, kaons etc. . . . ).

This invention shows how the energy to overcome the coulomb barrier can be accumulated and stored and finally be used (released) to induce the fusion process.

This invention additionally shows how such excess energy can be used to successfully induce additional fusion events (chained transmutations) or how such follow up events can be avoided.

Further on this invention gives a set of hard rules how such an environment must be built.

Finally this inventions defines the core physical process that leads to a large class of LENR/CMNS reactions.

### BRIEF DESCRIPTION OF THE DRAWINGS

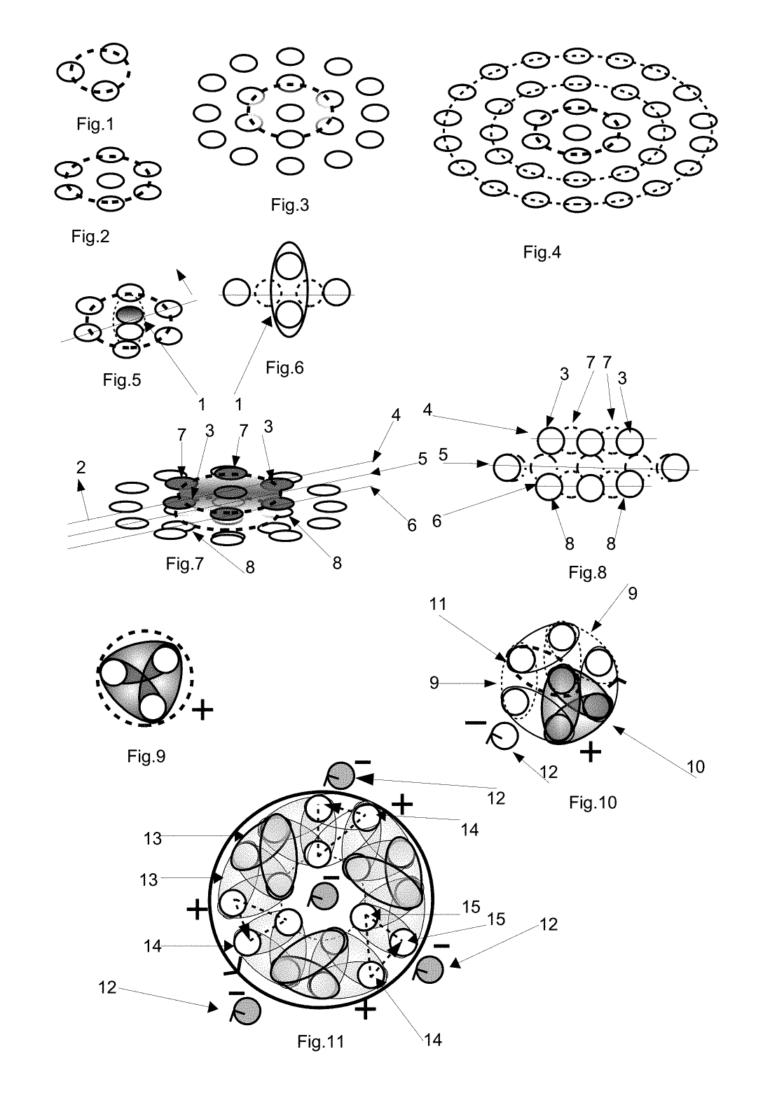

The first set of drawing, FIG. 1 . . . 4, shows the different set of simple, planar axial symmetric rotators.

The second set of drawings, FIG. 5 . . . 8, shows a set of different. Nested/stacked, rotators—planar and in sectional view.

The third set of drawings, FIG. 9 . . . 12, shows planar rotators with conjugated, stabilization by added charge.

The fourth set of drawings, FIG. 13 . . . 16, shows the different basic shapes of cavities.

The fifth set of drawings, FIG. 17 . . . 20, shows the different basic shapes of cavities together with embedded rotators.

The sixth set of drawings, FIG. 21 . . . 23, shows how charge-flow can ignite the startup of rotators and afterwards speed-up the rotator.

Drawing, FIG. 24, shows the situation for external stimulation by a varying E-field.

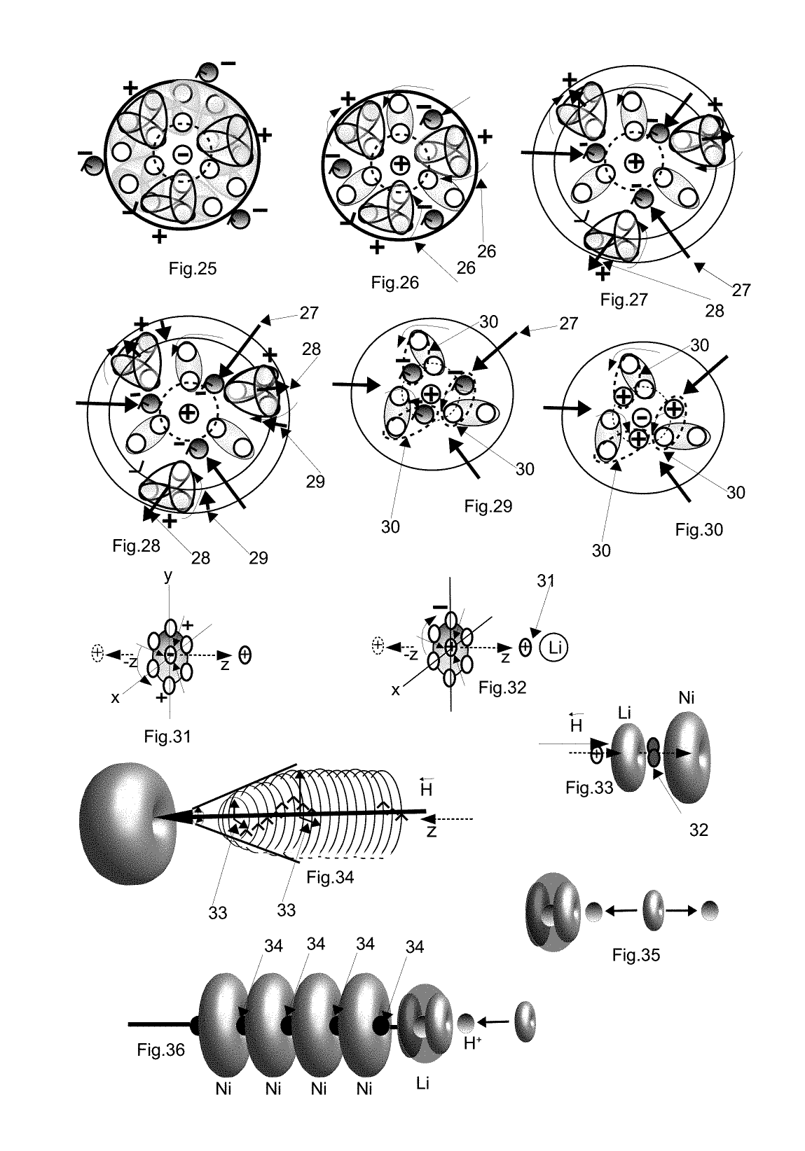

The seventh set of drawings, FIG. 25 . . . 32, shows possible steps of rotator collapse, charge disproportion together with the arsing forces.

The eighth set of drawings, FIG. 33 . . . 36, shows different overviews of the entire chain of possible physical (LENR/CMNS) reactions.

### DETAILED DESCRIPTION OF THE INVENTION

As shown in A1 WO2014189799 the lowest known amount of energy to reliably induce a high rate of LENR fusion events is between 50 and 100 eV for a proton beam entering a Lithium nucleus at well defined angle. Such high amounts of energy can only be stored inside condensed matter by the mean of using stable quasi molecular rotators.

Such rotators were identified to consist entirely of Hydrogen and added/removed charge. Only the center of the rotator can potentially consist of any fitting nucleus. The following basic forms of Hydrogen can be used for rotators: H (D); H⁻(D⁻); H₂ (D₂); H₂⁺(D₂⁺) H₃⁺(D₃⁺).

We restrict our presented examples/drawings to only use hydrogen (¹H). All laws/rules apply for (²H) too and only the material building the environment defines, which form of hydrogen will be efficient/successful.

Basic planar rotators preferably contain the following number of (rotating) hydrogen atoms (assuming center is hydrogen too): 3, 7, 19, 37, 61 named: H3 (FIG. 1), H7 (FIG. 2), H19 (FIG. 3), H37 (FIG. 4), H61. Out of these simple rotators, H3, H7, H19,37 are of main interest.

Such rotators can occur in stacked form, which doubles the number of rotating hydrogen. Also mixed stacks are likely e.g. H7, below/atop a H19. Basically all axial symmetric configurations of hydrogen, which present a stable axes of rotation, form such a rotator.

FIG. 5 (FIG. 6 sectional view) shows a H7 rotator with a center H₂ molecule (1) becoming a H8 rotator. FIG. 7 (FIG. 8 sectional view in plane direction (2)) shows a H19 rotator level (5), with two stacked (4—upper, 6—lower level), axially displaced inner H7 rotators. (3) points to intersection of outer hydrogen of top H7 rotator (8) points to outer hydrogen of bottom H7 rotator; (7) the covered hydrogen behind (4).

In such a rotator at least one ring of hydrogen is rotating around a common center. The most simple, effective rotator than can store a high amount of kinetic energy is H3⁺ FIG. 9.

The maximal frequency of such a rotator is given by the H—H (H₂) nuclear bond vibration, which is around 1.3725 E14 Hz. If the speedup happens quick enough—avoiding resonances—then higher frequencies should be possible.

The upper limits of energy, that single, planar rotator can mechanically store at the maximum frequency are: H3⁺: 23 eV; H7: 190 eV; H7⁺:328 eV; H19³⁺ 1313 eV. (H7+ assuming mediating a H₂⁺!) Some sample diameters of basic rotators given in nanometers at rest: H3⁺: 0.117 nm; H7: 0.181 nm; H7⁺: 0.237 nm; H19: 0.405 nm (uncharged) 0.34 nm fully charged; Charge will always change the diameter. Thus these values given are not fix.

All (except single H3⁺) the named basic rotators above can store enough energy to potentially induce a fusion—comparable to the energy level shown in A1 WO2014189799.

Three stacked H7+ or one H19³⁺ rotator contains enough energy (>680 eV) to directly induce a H—H fusion event which can happen below a nuclear radius of 2 pm. (pico meters).

If Lithium is used as a starter nucleus, then also a single H7⁺ rotator is potentially sufficient to start a single or a chained RCFC reaction.

To allow rotators to become rigid enough, to sustain higher rotational frequencies, charge must be added to hydrogen. Under plasma-conditions the slightly exothermic disproportion reaction 2H₂→H⁻+H₃⁺ may happen. The overall net energy balance is about 0.1 eV, which is typical for allowing conjugate states. H₃⁺ is very stable (days to weeks—see [L4]) especially the ortho spin-configuration state, which is expected to dominate in H₂.

Under the special condition inside cavities or on material surfaces, also mediating forms of the following reaction H₂+H₃⁺→2H_{2.5}^{+1/2} can be (meta-) stable. As soon as a rotator is moving quick enough disproportion reactions with the environment are very unlikely and the conjugate forms (in average H_{2.5}^{+1/2}) will be stable as long as the angular speed is high enough.

In FIGS. 10,11 we show a subset of possible conjugate states. H₃⁺ (FIG. 9) is a stable molecular conjugate that has been calculated in [L2, chpt. 13]. FIG. 10 shows a conjugated H7⁽⁺⁾ rotator stabilized by one external rotating charge (12). Mediating (9) is indicated by a dashed ellipsis. A virtual H₃⁺ (10) substructure and a stronger (11) virtual bond among two 2 hydrogen is indicated.

In FIG. 11 a more complex H17 conjugate is shown. Conjugate orbits (13). Internal charge (14) may flow and afterwards is mediated (15). External charge stays in place and is (12) represented by cavity bound rotating (J-state-clock-wise) The rotator (moving counter clock-wise) and the external clock-wise rotating H⁻ will not interact as higher J (>2) states are becoming very stable.

Although H₃⁺ seems to be the most abundant form of hydrogen in the universe, only few research has been done until 2000. Now the knowledge is increasing. Basic work on H₃⁺ recombination has been made in [L4]. An other crucial paper is referenced as [L1]. It shows that hot Hydrogen can be generated in disproportion reaction under “quite normal conditions” if H₃⁺ is present.

High J (rotational quantum number=energy stored in orbit as locked in photons) quanta also allow to potentially store large amounts of energy. Such states, if combined with a charge can, serve as a long time stabilization mean of charge bound rotators.

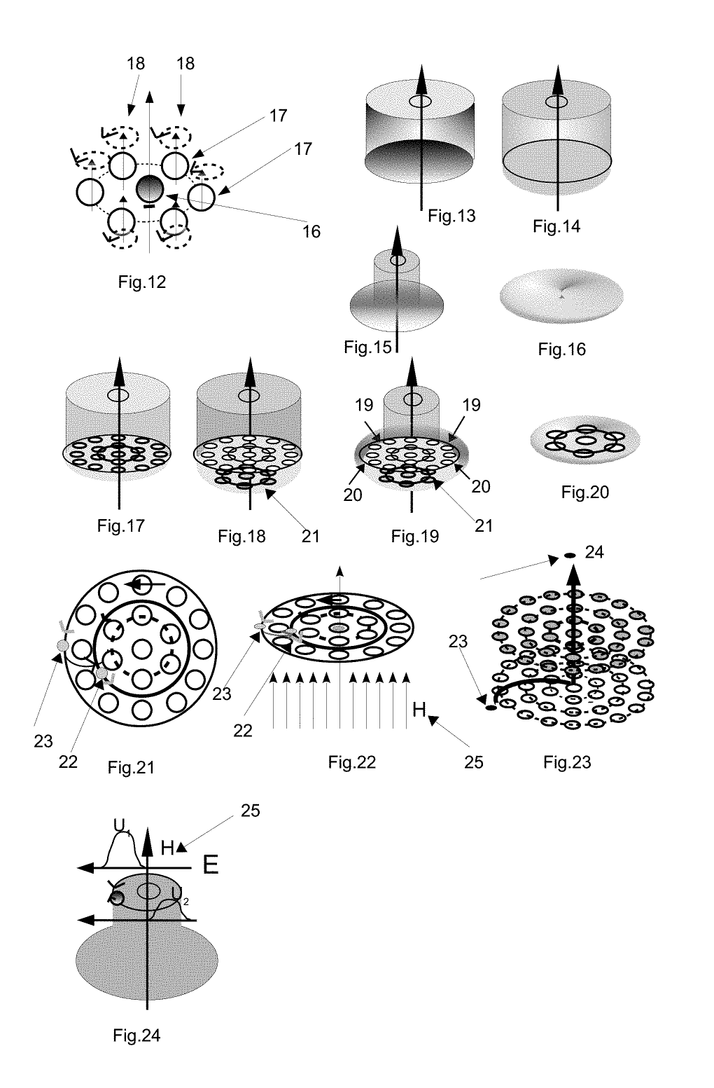

In FIG. 12 we show such a rotator consisting of six hydrogen (17) atoms (uncharged staying in place) at a high J state (indicated by arrow 18) stabilized by a central (flow of-) charge (16). This is the common situation encountered in arc/plasma-electrolysis, where a current stabilizes the two-fold (J—and around the axis given by the current) rotating charged hydrogen.

The current experimental knowledge of LENR/CMNR reactions does not allow to distinguish, whether a reaction has finally been promoted by a FIG. 12 type rotator or a conjugate one.

In fact, after one rotational cycle, a H₂ molecule, embedded in a rotator, has completed one rotation around its own center. At frequencies around 4*10¹³ Hz the rotator angular frequencies an the locked-in photon frequencies (Eₚₕₒₜₒₙ=0.0151 eV J⁰→J¹) start to match and possibly the states become undistinguishable.

In a productive process a big number of different rotators configurations can build out. We just give samples for simple ones. All rotators must fulfill two criteria: They must be stable enough to carry enough energy for inducing at least a RC event and they must carry charge to allow for a RCFC reaction.

The preferred environment of a stable rotator is the so called cavity. A cavity is a well shaped hole in a so called (Ni)AxByCz . . . or any other suited nano-particle, wire or any form of stable material. (Ax, By, Cz, . . . denote molar fractions of elements.). The typical size—diameter—of a cavity is below one nanometer.

Optimally such a cavity is of rotational symmetry, with the symmetry axes pointing outside (Needed for external E-field stimulation—FIG. 24). The simplest cavity shapes are cylinder (FIG. 13) or bullet (FIG. 14) form. Best fit shapes have a flattened spheric or conic-shape top to prevent rotator torque. One simple, optimal form is the flat bomb-shape (FIG. 15). The optimal closed shape is a cylinder-disk or an flat ellipsoidal shape (FIG. 16).

A slightly eccentric cavity can be used in the phonon stimulation mode. Small deviations from optimal cavity shapes can be compensated by excess hydrogen.

The wall of the cavity is preferably covered by one layer of metallic bound hydrogen, that is not rotating around the cavity center. Typically the nature of the bonding of such externally bound hydrogen is heavily fluctuating between non bound, magnetic bound or various conjugated bonds. More than one layer of hydrogen may help to easy the rotation, but will be counterproductive in the collapsing phase.

The diameter of the cavity must be selected, to be able to closely match the diameter of the used rotator(s) and the additional hydrogen bound to the cavity wall. This will optimally support the momentum mirroring/reflection during the collapse phase.

For the hydrogen, that is bound to Ni, surrounding the rotator, 0.106 nm must be added to the rotator diameter to get the target cavity diameter. Due to internuclear effects between H—Ni the orbits of Ni electrons can (any-time) expand/reduce by 0.01 nm.

In addition H—H ionic bonds undergo harmonic oscillations with amplitudes of up to 0.0054 nm, already at lower than the target resonance frequency. To avoid that vibration effects interfere with the moving rotator for each Hydrogen building the diagonal of a rotator a least a tolerance of 0.0054 nm must be added to the cavity diameter (per radial H—H bond equivalent).

In total up to 12% must be added to the planned [e.g. given in point 0038 and 0057] cavity diameter for compensation of thermic, doppler etc. vibrations, depending on process parameters.

Effects due to temperature change can work in both directions and must be calculated in, applying the specific parameters of the material used to build the cavity.

The above tolerance issue of [0058/59/60] can also be tackled/eased by allowing the rotator to smoothly follow up a bullet/bomb shaped bottom to acquire a “friction less” level inside the cavity. But this can introduce torque and lead to instability and finally loss of sub-critical rotators.

Flat bomb-shaped (FIG. 19), closed flat cylinder or plat ellipsoidal cavities provide a mean (19,20 indicate reaction forces mediating with cavity wall) to stabilize rotators and avoiding heavy torque. An other mean to stabilize a rotator is to use an external H-field (25) or to induce a permanent, homogenous magnetic field in the material used to build the cavities.

FIG. 17,18,19,20 Illustrate different sets of H7, H19 rotators that optimally fit into some presented cavities. With 21 a H7 rotator below a H19 rotator is indicated.

The startup in FIG. 21,22,23 of a rotator is induced by a momentum transfer of a radial charge flow (position 23→22 or 23→24)—typically happening outside in. If a symmetric conjugate state is building out spontaneously—like in a super-conductor—then rotation may start without external support. In FIG. 23 charge is flowing along the rotator axes which will build up a H (B) field that supports the rotation.

To prevent chaotic mixing of rotator directions, at rotator startup, a static H (B) field (25) should be present. An other mean to attain this state, is (if adequate all) to selectively (in situ) magnetize the carrier material (nano-particles, etc.).

There are three basic modes to ramp up the rotation speed of rotators:

Radial charge momentum transfer using external EM stimulation FIG. 24. In FIG. 24 an asymmetric flow of a charge density wave around the open cavity provides a potential (e.g. U2−U1) difference, which can drive an external charge rotating in the field built up by the charged rotator. Thus magnetic energy is mediated to the rotator by periodically increasing the field (25) density.

Phonon resonances between rotator and cavity wall can happen, due to slight asymmetries—eccentricity; Phonon resonances must either happen at known eigenstates of the built resonators or the stimulation by the environment must follow the rotator frequency.

Phonon resonances can be modulated by increasing/decreasing the temperature. Clever designed (x:y:z standing wave) nano-particles can produce well matching higher harmonics, that can follow/couple with also with fast spinning rotators.

As shown in FIG. 23, a constant charge flow (tangentially in 23→24—axially out) between two layers of rotators can continuously deliver added momentums. Such charge (−) can e.g be delivered by H− in higher (J=1) states, which guarantees a high tangential infusion speed. If e.g. an electron is accelerated by the positive rotator charge, then no energy is won!

This method needs careful evaluation if used.

Also mixed forms of stimulation are possible. E.g.: Lower-speed small rotators can be employed, by modulating their speed, just for the purpose of pumping in H (B) field energies to larger rotators.

The only, non interfering (most independent of used material) method to stimulate rotators, is external radial charge-momentum transfer as of [0067]. E/H-fields can also be used to drive/modulate phonon stimulation. This method (Em-stimulation) is known to the field and we only explain how it works together with a rotator.

Any external H/E field stimulation (frequency) should be optimized to fit (optimal coupling) the currently active rotator speed(s). In an optimally designed reactor the speed(s) of the charged rotators can be correlated (averaged), with the H field that is pointing axially out/in (depending on rotator ignition mode—field direction) of the cavity.

The first ignition phase of a RCFC-LENR reaction is the rotator collapse (RC-phase) shown in FIGS. 25 . . . 32. E.g.: Due to reaching a resonance point, an instability can lead to breaking bonds and decay of the rotator. Within one rotation, 10⁻¹⁴ sec., a complete molecular disproportion may build out. The RC-collapse is completed, when the center Hydrogen gets expelled and successfully carries away the radially delivered momentum FIG. 31.

Due to angular momentum conservation and radial forces closely averaging to 0, we can draw the following simplified picture: E.g.: The outer ring of a e.g. a charged H19 rotator (consisting of 12 hydrogen atoms) must move, in average, radially outwards, where as the inner, still partially charged ring of the H7 sub-rotator gets slightly contracted.

Due to radial forces (27 inwards, 28 outwards, and 29 inwards reflected) and angular momentum conservation, molecular parts start clock/counter wise rotations (26—winded arrows). Such new local angular momentum can ramp up very quickly and are able to further amplify the radial forces.

The mean free path of radially outside “ejected parts” is—given a well designed cavity—very short and the outside forces (28) will get partially reversed by the reflected (at cavity wall 29) momentums. Assuming a single planar H19 rotator: After a first reflection about 40% of the total rotator energy is delivered radially inwards.

If molecular parts carry higher energies than typically 27.2 eV further disproportion reactions (e.g.: Inside moving H⁻ (30) knocking rotating H₂— within dashed ellipses) as given by [L2], experimentally shown by [L1] can happen, which generates additional “freed energy” originating from electrons forced into deeper orbits.

In the optimal case—“tight coupling” between cavity walls and rotator—such an instability happens under total symmetry and leads to a coordinated—(rotator-) internally mediated—orbital collapse, which frees additional potential coulomb energy and finally amplifies the collapsing disproportion movements. Known processes, where such events happen, are sono-fusion in e.g. Pd/D₂O environments.

The key point, for understanding the RCFC-effect is the following: A charged rotator (e.g. three rotating ‘+’ charges) correspond to a ring current that is in the range of 0.00005 A. (at about 10¹⁴ Hz.) If e.g. the (+) charges FIG. 30 moves radially inside (we assume here the collapse was ignited by a central negative charge), then the original current gets multiplied by the amplification factor Aᵣ=r_{original}/r_{final}.

In the opposite case FIG. 29, assuming a positive charge in the center causing the collapse, the potential change in the current can be much higher, if the negative charges are stable enough bound e.g. as in H⁻. Then, first the original field gets reversed, before the strong short-time field will ramp up.

If these charges are mechanically forced to move radially inwards, already a small (e.g. factor 2) radial difference is sufficient to induce a doubling of the effective current. To keep its angular momentum the inward forced part of the rotator must increase it's frequency. In such a case (Aᵣ=2) the resulting current averaged over time (one rotation!) dl/dt=5*10⁹, is very high! Further on, by a shrinking radius, the magnetic flux density is increased too.

Many LENR experimenters were reporting peak field strengths strong enough to damage equipment and to severely disturb far away electronic components. Our model can explain why and how this strong magnetic field occurs. In fact, even a radial contraction of just 10% is enough, if the angular momentum is conserved. Such a small contraction is well within a diameter change of a center H⁻→H or can be caused by the RC effect itself.

The concrete generated field depends on many other factors, like the effective ramp-up time of a shrinking rotator, which may last much longer than one rotation. Also the coupling of charge and the carrying particle undergoing acceleration is not absolutely fix. The impedance of the “medium”, including interaction with fields of neighboring nuclei can strongly damp the ramp up of a current through the coupled field.

In our model, such a strong field, in line with the rotator axes, exerts a strong force on a neighbor (FIG. 33,34) nucleus, which will try to bring its center in inline with the axes. This will lead to an optimal scattering angle close to 180 degrees. The field itself is not a prerequisite of a successful fusion event. But it will strongly enhance the yield.

By-product: If a full RCFC (strong field plus ejected hydrogen/proton) events happens, but no Lithium is present and the energy is to low to induce an Ni—H fusion event, it is still possible to produce stable toroidal hydrogen (corresponding to H*(1/5), orbit at ca. −340 eV), as calculated in [L3]. For that purpose a field os 2.4*10⁵ Teslas is needed as calculated in reference [L3].

In suboptimal cases, when only a partial radial collapse (RC effect) happens or only a low energy RCFC effects occurs, a follow up reaction is still possible, if the ejected proton (31) FIG. 32 hits a Lithium nucleus.

During the same interval where the magnetic field gets ramped up, the forces on the center proton will increase too. The center H finally gets expelled by the momentums (typically half of the energy) it takes over form the radial inside forces. As shown in FIG. 30 it can either move in + or −z (axial) direction. The acceleration is mainly of mechanical nature and the particle will quasi fly behind the still ramping up field.

The induced ultra strong magnetic field allows charged particles only to move in (+−) z direction (along rotation axes), with possibly a very small (x,y) radial component.

If a rotator, as in FIG. 5,6 and schematically shown in FIG. 35 is given, then two center protons, FIG. 34, share the momentums produced by the collapse and a hit is “guaranteed”.

If, FIG. 31, the proton moves in direction (31) of the Lithium located inside the cavity wall or already attracted (staying below rotator, inside the cavity) by the rotator, then a fusion event with low proton impact energy, in analogy to WO2014189799, can happen.

In our RCFC case the induced H-field is toroidally (as in shown in [L3]) distorting/coupling to the Lithium's coulomb-barrier, what will forcing an alignment with the neighbor nucleus. This will work well for nearly aligned nuclei. Further the collapsing rotator, shown in FIG. 31,32, is delivering the momentum for the proton.

Side-path: If the ignition is done by directly adding Lithium to the moving rotator center, then a LENR reaction can potentially immediately start due to the low threshold of Li.

In the optimal case a strongly symmetric, coordinated (illustrated in FIG. 34) orbital collapse produces a quasi linear avalanche effect FIG. 33, 36. The energy density of the accompanied magnetic field follows a dr³ amplification and depending on the energy produced by the disproportion reaction virtually any level of impact energy up to 3 MeV (for one fully collapsing H7 ring) can be produced.

In such an optimal case, given that all coulomb forces of the six involved most inner hydrogen finally point inside, up to 6×511 keV can be given to the center proton(s). (In the ²H—²H case direct production of 4He can happen.) If the center Hydrogen collapses too, then up to 7×511 keV can be freed and a neutral H* is ejected. If two stacked H19 rotators are involved or one shown in FIG. 7,8 then these energies may double.

Even at much lower than maximal possible energies, e.g. at radial contraction FIG. 34. (33) of r→r/5, the generated field can successfully couple with more than one neighboring nucleus, in a manner that some neighboring nuclei get center aligned with the ejected proton FIG. 32. An ultra strong field is also able to promote the toroidal polarization to an aligned nucleus behind e.g. Li.

From ash analysis of NiLiH-LENR experiments it is known, that Lithium can eject one neutron/H* (nuclear charge equivalent) and that Nickel (Ni) mostly undergoes transmutations which follow Z+2 rule—e.g.; ⁵⁸Ni→⁶⁰Ni→⁶²Ni. The overall reaction is shown in two steps: ⁷Li+H→⁶Li+²H* . . . ²H*+^{Z}Ni→^{z+2}Ni.

Whether this exchange of nuclear charge (FIG. 33,32 or 36, 34) is directly mediated by the involved nuclei inside a guiding “toroidal magnetic field cavity” or whether this nuclear charge gets ejected and re-adsorbed, is not yet known. The neutral ²H* exchanged nuclear charge, could also be a collapsed hydrogen complex. Further research is needed to evaluate the details.

What is known from ash analysis is, that “large range” nuclear charge re-distribution may happen. Our effect explains, that such events only can happen, if after a first ignition, axially aligned nuclei FIG. 33, FIG. 36 are present. Inside a toroidal coupled field the nuclei are free to move in axial direction!, and only mutual nuclear coulomb repulsion is defining their distance.

Potentially any initial LENR fusion event will provide enough central input momentum to allow a chained redistribution reaction. Such redistribution reactions have been seen in other LENR experiments too. E.g. in arc-electrolysis, where such events have shown no excess energy. But such redistribution can only happen if a strong field aligns the nuclei!

Our model explains that ultra high local magnetic fields can be generated, that can lead to chains of toroidally field coupled nuclei. Depending on the goal (elemental transmutation or energy) of a productive reactor, this effect (FIG. 36) must be allowed or forbidden.

To allow for such reactions [0099], the lattice must provide a connected edge of lined up nuclei, parallel/in line with the rotator axes. To avoid such reactions, follow up nuclei must be presented at large enough angle, to prevent the action of the induced magnetic field.

1: The energy to start a RCFC-low energy nuclear reaction is stored in compact, charge stabilized quasi molecular rotators.

2: Such rotators as given under 1: may contain the following molecular, atomic substructures: H (D); H⁻(D⁻); H₂ (D₂); H₂⁺(D₂⁺) H₃⁺(D₃⁺) except the center of rotation, which could contain any fitting nucleus.

3: Such rotators as given under 2, preferably entirely made either of ¹H or ²H, may be of single layer form (H3, H7, H19, H37, H61, . . . ) or consist of multiple stacked layers of single rotators.

4: Such rotators as given under 3: Must preferably be of axial symmetry and can consist of any mixture—stacked, interleaved—of the preferred rotators.

5: Such rotators as given under 4 are stabilized (made more rigid) by charge or conjugated mediated charges.

6: Such rotators as given under 5:—under strong internal coupling—can have any symmetric hydrogen configuration, which provides a stable single rotation axis.

7: Such rotators as given under 6—inside cavities can harvest either phonon energy, externally provided electromagnetic energy or acquire the momentum of preferably radially inbound traveling charge (electrons etc.) that will be centrally expelled along the rotator axes.

8: For Such rotators as given under 6: For a synchronous startup of rotators or to stabilize running rotators a homogenous external or internal magnetic field, preferably pointing along the rotator axes, can be used.

9: The preferred stable environment to hold one or an arbitrary high stack of mixed (H3, H7, H19, H37, H61, . . . ) or any rotators claimed under 6 above is the cavity.

10: Cavities as given under 8 must preferably be of rotational symmetry and can have a small eccentricity—in relation to the spinning axis—to allow phonon stimulation.

11: Cavities as given under 9: The bottom and top of optimal such cavities should preferably be of flat spherical/conical shape to allow for only a small up/downward rotator torque/movement.

12: Cavities as given under 10—open or closed—are optimally of bomb-shape, bullet shape, closed flat cylinder or plat ellipsoidal.

13: Cavities as given under 9, that allow direct external rotator stimulation, should be close surface or surface open.

14: The RCFC-low energy nuclear reaction is caused by an (optimally) symmetrically collapsing rotator, which provides, after reflection at the cavity wall, a radially inside pointing momentum, —finally needed for particle (proton, H*, ²H, ²H*) acceleration, by mechanical thrust, where the transported momentum ideally is pointing in direction/prolongation of the rotator axes.

15: Such a reaction, as given under 14, can in parallel produce a strong temporal H-field—induced by fast accelerating, orbiting, forced radially inwards traveling charges, that guides the needed field coupling by toroidally polarizing the coulomb barrier (electron cloud) of an the adjacent nucleus.

16: To amplify—such a reaction as given under 14, —at lower rotator energies —, in the case of Ni—H, Lithium should be present at the cavity bottom, below the rotator axis.

17: To induce—such a reaction as given under 14—Lithium can also be internally/externally forced into high power rotators by an electrical bias field of +−50 to 1000V to directly induce a RCFC reaction.

18: Such a reaction as given under 15 can be used for further transmutations, if the lattice hosting the cavity/rotator, in the prolongation of the rotator axes and the reacting nucleus, contains one or a chain of connected Ni or other nuclei.

19: Such a reactions as given under 18 can be avoided, if the lattice, hosting the cavity/rotator, in the prolongation of the collapsing rotator axes, does not present centers of multiple neighboring nuclei.

20: Such a reaction as given under 15 can generally be used, to induce any nuclear transmutation, that starts with adding H or ²H (D), H*, ²H* nuclear charge equivalent to a target nucleus.
